(19) United States
(12) Patent Application Publication
(10) Pub. No.: US 2013/0104081 A1
(43) Pub. Date: Apr. 25, 2013

(54) DISPLAY APPARATUS, DISPLAY METHOD AND COMPUTER-READABLE MEDIUM

(71) Applicant: CANON KABUSHIKI KAISHA, Tokyo (JP)

(72) Inventor: Ken Tokita, Kawasaki-shi (JP)

(73) Assignee: CANON KABUSHIKI KAISHA, Tokyo (JP)

(21) Appl. No.: 13/633,951

(22) Filed: Oct. 3, 2012

(30) Foreign Application Priority Data
Oct. 20, 2011 (JP) 2011-231095

(51) Int. Cl. G06F 3/048

(52) U.S. Cl. 715/838

(57) ABSTRACT

A display apparatus including a display unit which receives input upon a tap on a display screen, comprises a property display unit configured, when a thumbnail image of data displayed on the display screen is tapped, to change a display region of the thumbnail image to a property screen indicating property information of the data corresponding to the thumbnail image.

### BACKGROUND OF THE INVENTION

1. Field of the Invention

The present invention relates to a display apparatus, display method, and computer-readable medium for displaying the property information of a document. The present invention relates, more particularly, to a technique of tapping a thumbnail image of a document on a thumbnail list screen, thereby changing the thumbnail image to a property screen of the document.

2. Description of the Related Art

Recently, opportunities to use document management systems via touch panel terminals are increasing. To confirm the property information (for example, the registrant, update date, and size) of a document managed by a document management system via, for example, a document management tool, a method of displaying this property information by displaying a pop-up screen upon mouse-over is efficient when this display is done via a thumbnail list screen on a PC. However, when a touch panel terminal has no cursor on the screen, a pop-up screen cannot be displayed upon putting the cursor on an appropriate thumbnail image. Therefore, the user must temporarily download a document or open another window to confirm the preview or property information of the document.

As a technique of displaying a property screen opened as another window, a method as described in Japanese Patent Laid-Open No. 2002-175138 is available. In the method described in Japanese Patent Laid-Open No. 2002-175138, the number of display operations is counted for each of a plurality of property sheets which construct a property screen, and a property sheet to be preferentially displayed on the property screen is changed based on the count of display operations.

Unfortunately, in the method of displaying property information on another window as mentioned above, it takes a lot of trouble and time for the user to directly confirm the property information of a document or to confirm the pieces of property information of a plurality of documents, thus degrading the operation efficiency.

### SUMMARY OF THE INVENTION

The present invention has been made in order to solve the above-mentioned problem, and provides a technique of tapping a thumbnail image of a document on a thumbnail list screen, thereby changing the display region of the thumbnail image to a screen which displays the property of the document. This provides a property display system capable of easily displaying viewable property information.

According to one aspect of the present invention, there is provided a display apparatus including a display unit which receives input upon a tap on a display screen, comprising: a property display unit configured, when a thumbnail image of data displayed on the display screen is tapped, to change a display region of the thumbnail image to a property screen indicating property information of the data corresponding to the thumbnail image.

According to another aspect of the present invention, there is provided a display apparatus that is connected to an external apparatus which manages data, and includes a display unit which receives input upon a tap on a display screen, comprising: an acquisition unit configured, when a thumbnail image of data displayed on the display screen is tapped, to acquire property information of the data corresponding to the thumbnail image from the external apparatus; and a property display unit configured to change a display region of the thumbnail image to a property screen indicating the property information acquired by the acquisition unit.

According to another aspect of the present invention, there is provided a display method for a display apparatus including a display unit which receives input upon a tap on a display screen, comprising: a property display step of, when a thumbnail image of data displayed on the display screen is tapped, changing a display region of the thumbnail image to a property screen indicating property information of the data corresponding to the thumbnail image.

According to another aspect of the present invention, there is provided a display method for a display apparatus that is connected to an external apparatus which manages data, and includes a display unit which receives input upon a tap on a display screen, comprising: an acquisition step of, when a thumbnail image of data displayed on the display screen is tapped, acquiring property information of the data corresponding to the thumbnail image from the external apparatus; and a property display step of changing a display region of the thumbnail image to a property screen indicating the property information acquired in the acquisition step.

According to another aspect of the present invention, there is provided a non-transitory computer-readable medium storing a program for causing a computer to function as: a property display unit configured, when a thumbnail image of data displayed on a display screen of a display unit which receives input upon a tap on the display screen is tapped, to change a display region of the thumbnail image to a property screen indicating property information of the data corresponding to the thumbnail image.

According to another aspect of the present invention, there is provided a non-transitory computer-readable medium storing a program for causing a computer to function as: an acquisition unit configured, when a thumbnail image of data which is managed by an external apparatus and displayed on a display screen of a display unit which receives input upon a tap on the display screen is tapped, to acquire property information of the data corresponding to the thumbnail image from the external apparatus; and a property display unit configured to change a display region of the thumbnail image to a property screen indicating the property information acquired by the acquisition unit.

According to the present invention, the user can easily confirm the property information of a document even when he or she uses a touch panel terminal.

Further features of the present invention will become apparent from the following description of exemplary embodiments with reference to the attached drawings.

### BRIEF DESCRIPTION OF THE DRAWINGS

FIG. 1 is a block diagram showing the concept of a document management system;

FIG. 2 is a block diagram showing the hardware configuration of a document management server apparatus;

FIG. 3 is a block diagram showing the software configuration of the document management server apparatus;

FIG. 4 is a block diagram showing the hardware configuration of a client apparatus;

FIG. 5 is a block diagram showing the software configuration of the client apparatus;

FIG. 6 is a view showing a document thumbnail list display screen displayed on a touch panel display;

FIG. 7 is a view illustrating an example of a setting screen of modes upon a tap of a thumbnail image;

FIG. 8 is a view showing a thumbnail image tap action which changes depending on the mode;

FIGS. 9A and 9B are views each showing a property display transition of a document upon a tap of a thumbnail image;

FIG. 10 is a view showing a property display order setting screen;

FIGS. 11A and 11B are views showing a change in property display order before and after an attribute search of a document;

FIG. 12 is a view showing a property display order detail setting screen;

FIG. 13 is a flowchart of setting and storage processing upon thumbnail image tap action setting;

FIG. 14 is a flowchart of setting and storage processing upon property display order setting;

FIG. 15 is a flowchart of operation processing upon a tap of a thumbnail image;

FIG. 16 is a view showing a document thumbnail list display screen according to the second embodiment;

FIG. 17 is a view showing a folder content information display transition upon a tap according to the second embodiment;

FIG. 18 is a flowchart of operation processing upon a tap according to the second embodiment;

FIG. 19 is a view showing a document thumbnail list display screen according to the third embodiment;

FIG. 20 is a view showing a document thumbnail image display screen upon a tap according to the third embodiment;

FIG. 21 is a flowchart of thumbnail generation processing upon document registration according to the third embodiment; and

FIG. 22 is a flowchart of operation processing upon a tap according to the third embodiment.

### DESCRIPTION OF THE EMBODIMENTS

Modes for carrying out the invention will be described below with reference to the accompanying drawings.

### First Embodiment

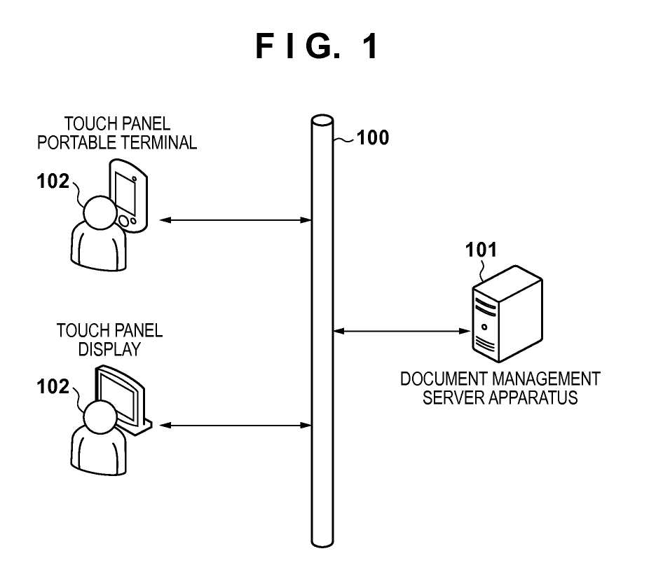

The first embodiment of the present invention will be described with reference to FIGS. 1 to 15.

System Configuration

FIG. 1 is a block diagram showing the entire configuration of a system including a document management server apparatus according to this embodiment. The system includes a document management server apparatus 101 and client apparatuses 102, which are communicably connected to each other via a network 100.

The document management server apparatus 101 implements a function of managing documents for each version, and provides managed document information and files in response to requests from the client apparatuses 102. Note that the document management server apparatus 101 may be physically implemented by one apparatus or implemented by a plurality of apparatuses upon load distribution.

Each client apparatus 102 is a touch panel apparatus, which serves as an intermediary which allows the user to display and manipulate the document information in the document management server apparatus 101. As shown in FIG. 1, the number of client apparatuses 102 in the network 100 is not particularly limited to one, so a plurality of client apparatuses 102 can be connected to the network 100, and may be implemented by apparatuses with different capabilities as long as they include displays serving as touch panel display units. A touch panel portable terminal, for example, corresponds to the client apparatus 102.

Although the network 100 will be described by taking the Internet as an example in this embodiment, other networks such as a local area network (to be abbreviated as a LAN hereinafter) may be used.

Hardware Configuration of Document Management Server Apparatus

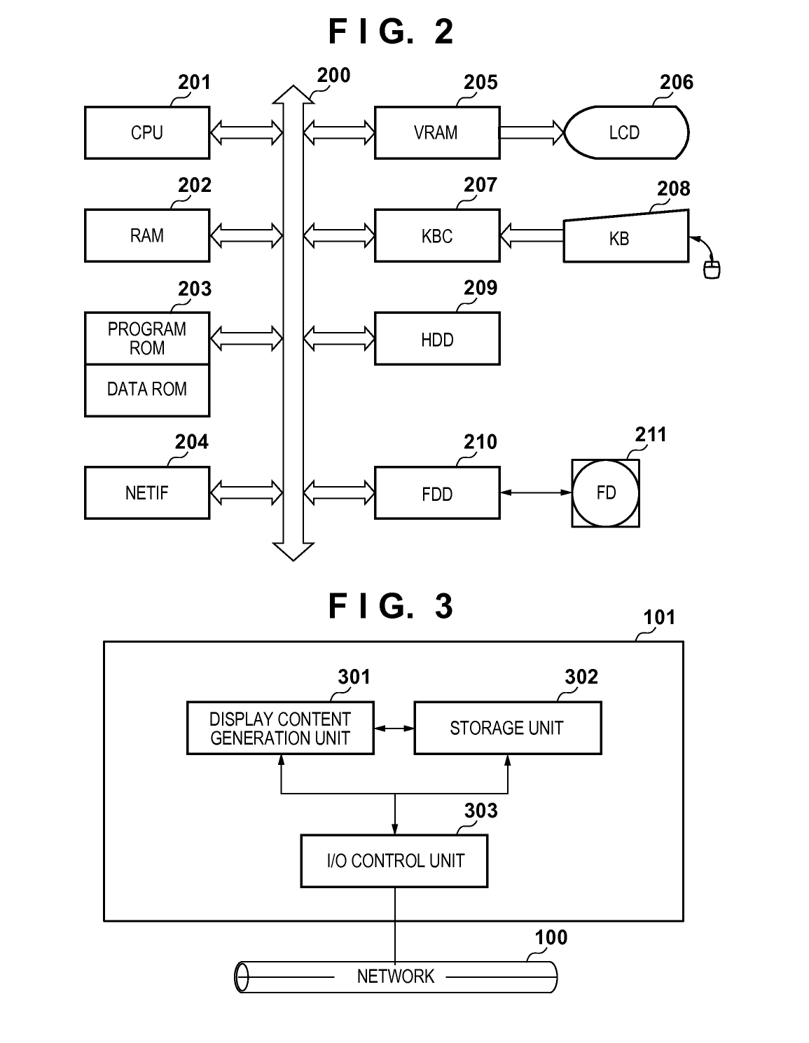

FIG. 2 is a block diagram showing the hardware configuration of the document management server apparatus 101 according to this embodiment. A central processing unit (CPU) 201 performs arithmetic processing and control of the information processing apparatus. A random access memory (RAM) 202 functions as the main memory of the CPU 201. The RAM 202 also functions as a storage area for an execution program, an execution area for the execution program, and a data area for the execution program.

A read only memory (ROM) 203 stores a program for implementing the operation processing procedure of the CPU 201. The ROM 203 stores a program ROM which records basic software (OS) serving as a system program for controlling devices in the information processing apparatus, and a data ROM which records, for example, information required to operate the system. A hard disk drive (HDD) 209 is also often used in place of the ROM 203.

A network interface (NETIF) 204 performs, for example, control data transfer with an external apparatus via the network 100, and diagnosis of the status of connection of the document management server apparatus 101 to the network 100. A video RAM (VRAM) 205 expands an image to be displayed on the screen of a display apparatus (LCD) 206, and controls display of the image.

The display apparatus (LCD) 206 is, for example, a display which displays, for example, the operating status of the information processing apparatus. A keyboard controller (KBC) 207 serves to control a signal input from an external input device (KB) 208. The external input device (KB) 208 serves to receive an operation by the user. A pointing device including, for example, a keyboard and mouse is used as the KB 208.

The hard disk drive (HDD) 209 stores, for example, application programs and various data. The application programs include, for example, software programs for executing various processing units according to this embodiment.

An external I/O device (FDD) 210 serves to input/output data on a removable disk including a magnetic recording medium such as a flexible disk drive, an optical recording medium such as a CD-ROM drive, or a magnetooptical recording medium such as an MO, or a semiconductor recording medium such as a memory card. The external I/O device (FDD) 210 is used to read out, for example, the above-mentioned application programs from the recording medium.

A removable medium (FD) 211 is a detachable data recording medium which stores the data read out by the external I/O device (FDD) 210. Examples of the removable medium (FD) 211 include a magnetic recording medium (for example, a flexible disk), an optical recording medium (for example, a CD-ROM), a magneto-optical recording medium (for example, an MO), and a semiconductor recording medium (For example, a memory card).

Note that application programs and data stored in the HDD 209 can also be read out from the FD 211 by the FDD 210 and used.

Software Configuration of Document Management Server Apparatus

FIG. 3 is a block diagram showing the software configuration of the document management server apparatus 101 according to this embodiment. The document management server apparatus 101 includes a display content generation unit 301, storage unit 302, and I/O control unit 303.

The display content generation unit 301 generates and formats display information for displaying on the client apparatus 102 the processing results obtained by other processing units. The storage unit 302 is implemented by a memory such as the HDD 209, and stores document information and I/O information acquired by the document management server apparatus 101.

The I/O control unit 303 controls data transfer to and data reception from the client apparatus 102.

Hardware Configuration of Client Apparatus

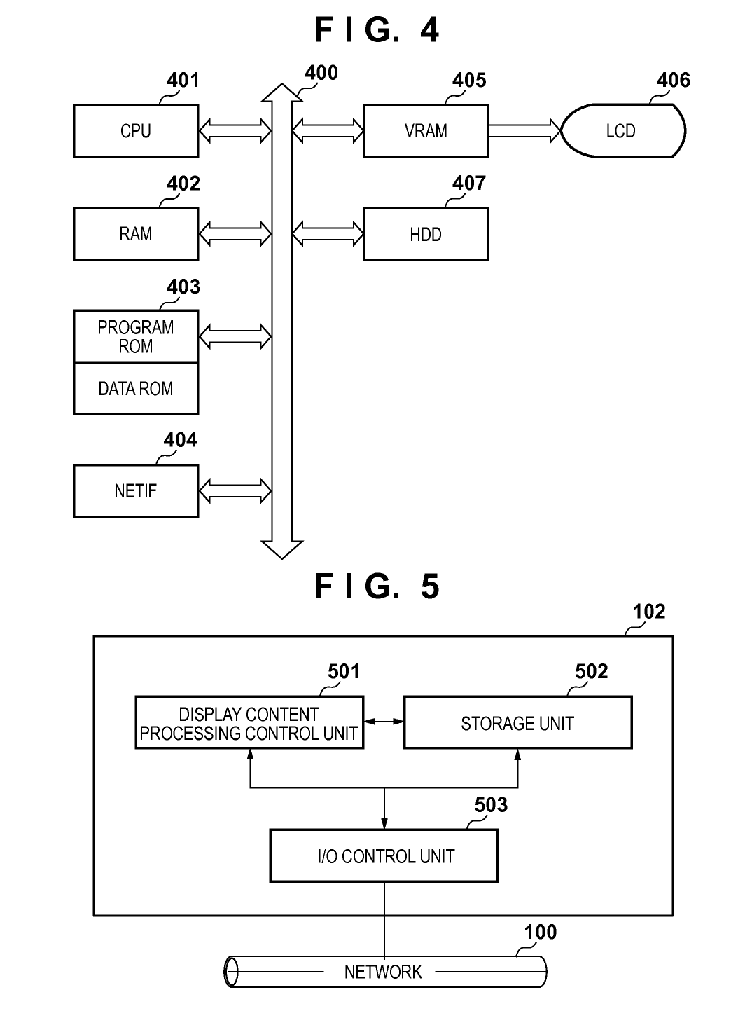

FIG. 4 is a block diagram showing the hardware configuration of the client apparatus 102 according to this embodiment. A central processing unit (CPU) 401 performs arithmetic processing and control of the information processing apparatus. A random access memory (RAM) 402 functions as the main memory of the CPU 401. The RAM 402 also functions as a storage area for an execution program, an execution area for the execution program, and a data area for the execution program.

A read only memory (ROM) 403 stores a program for implementing the operation processing procedure of the CPU 401. The ROM 403 stores a program ROM which records basic software (OS) serving as a system program for controlling devices in the information processing apparatus, and a data ROM which records, for example, information required to operate the system. A hard disk drive (HDD) 409 is also often used in place of the ROM 403.

A network interface (NETIF) 404 performs, for example, control data transfer with an external apparatus via the network 100, and diagnosis of the status of connection of the client apparatus 102 to the network 100. A video RAM (VRAM) 405 expands an image to be displayed on the screen of a display apparatus (LCD) 406 (to be described later), and controls display of the image.

The display apparatus (LCD) 406 is, for example, a display which displays, for example, the operating status of the information processing apparatus. The LCD according to this embodiment can be operated via a touch panel. A hard disk drive (HDD) 407 stores, for example, application programs and various data. The application programs in this embodiment include, for example, software programs for executing various processing units according to this embodiment.

Software Configuration of Client Apparatus

FIG. 5 is a block diagram showing the software configuration of the client apparatus 102 according to this embodiment. The client apparatus 102 includes a display content processing control unit 501, storage unit 502, and I/O control unit 503.

The display content processing control unit 501 interprets a display content received from the document management server apparatus 101, and displays it on the LCD 406. Also, the display content processing control unit 501 transfers, to the document management server apparatus 101 via the I/O control unit 503, transfer information generated in accordance with information input via the touch panel on the LCD 406.

The storage unit 502 is implemented by a memory such as the HDD 407, and stores document information and I/O information acquired by the client apparatus 102. The I/O control unit 503 controls reception of input by the user, and data transfer to and data reception from the document management server apparatus 101.

Operation Setting upon Tap of Thumbnail Image

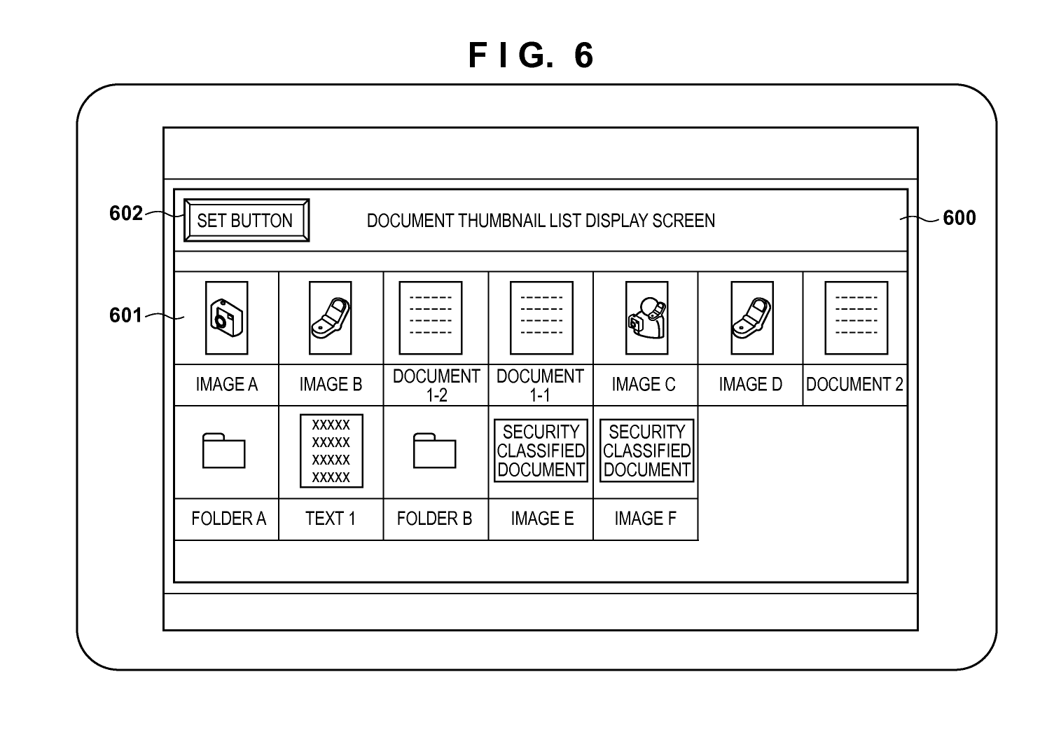

Processing of setting an operation mode when the user taps a thumbnail image corresponding to data (a file containing, for example, a document or an image) according to this embodiment will be described below with reference to FIGS. 6 to 8.

FIG. 6 illustrates an example of a document thumbnail list display screen 600 displayed on the LCD 406 of the client apparatus 102 when the user accesses (logs into) the document management server apparatus 101 via the client apparatus 102. Note that a search result screen displayed when the user searches for a document, and a folder content screen displayed when he or she selects a folder are similar to the document thumbnail list display screen 600. Although not shown in FIG. 6, the path of a displayed folder may be displayed.

In this embodiment, in a method of searching for a document managed by the document management server apparatus 101, attribute information (property attributes) included in the property information, such as the name and creator, of a document to be searched for is input to a search text box (not shown) on a document search screen. A document having attribute information which matches or is similar to the input attribute information is displayed. However, the searching method is not limited to the above-mentioned method.

The document thumbnail list display screen 600 displays thumbnail images 601 side by side for each document. The document thumbnail list display screen 600 displays not only thumbnail images of documents but also thumbnail images of image data and icon images of folders. A set button 602 serves to perform property display order setting, and setting for switching the display operation upon a tap of a thumbnail image.

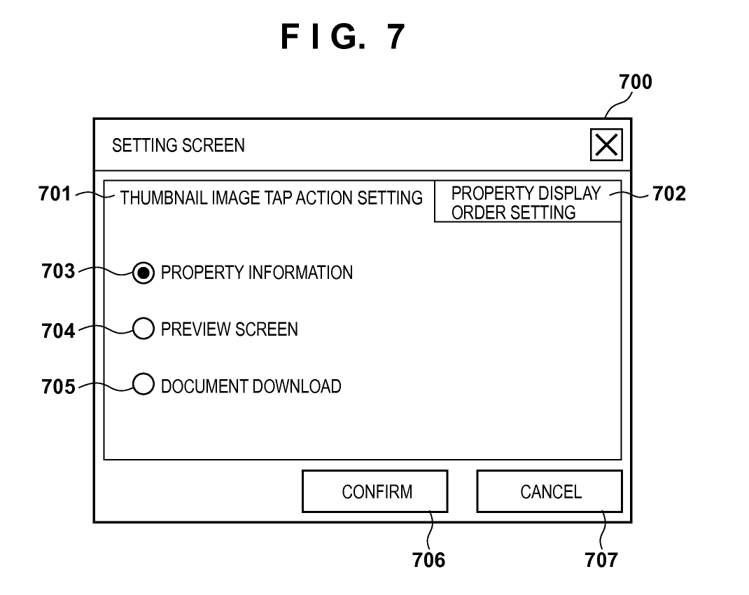

FIG. 7 illustrates an example of a setting screen 700 displayed when the user presses the set button 602 on the document thumbnail list display screen 600 shown in FIG. 6. The setting screen 700 includes a thumbnail image tap action setting sheet 701 and property display order setting sheet 702. Note that setting information to be set in this case will be referred to as thumbnail image tap action setting information hereinafter.

The thumbnail image tap action setting sheet 701 provides an example of a screen which allows the user to set an operation mode upon a tap of a thumbnail image. In this embodiment, an operation mode enabled upon a tap of a thumbnail image is selected from the following three modes. That is, the user can set a “Property Information” mode 703 in which property information is displayed, a “Preview Screen” mode 704 in which a preview screen is displayed, or a “Document Download” mode 705 in which a document is downloaded. When the user selects one of the operation modes and presses a confirm button 706, this setting operation is completed. When the user presses a cancel button 707, the setting information of the selected mode is not reflected. Also, in this embodiment, the “Property Information” mode 703 is set as the initial setting mode.

In this embodiment, a mode is set on the setting screen 700. Note that the modes upon a tap of a thumbnail image are not limited to those shown in FIG. 7, and other modes may be selectable. The display operation upon a tap is switched by this mode designation operation. Also, an operation mode to be set may be changed for each of different operations for thumbnail images, such as a single tap (an operation of tapping a thumbnail image once), a double tap (an operation of quickly tapping a thumbnail image twice), and a long press.

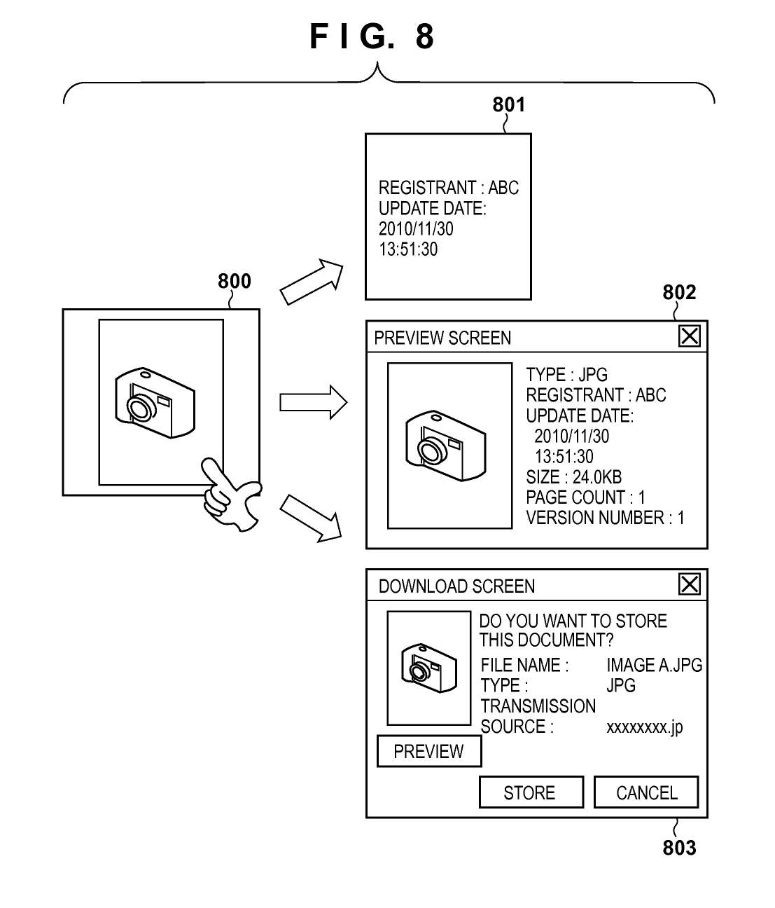

FIG. 8 is a view showing an action which changes depending on the operation mode upon a tap of a thumbnail image, which is set on the setting screen 700 shown in FIG. 7. If the “Property Information” mode 703 is set, when a thumbnail image 800 is tapped, property information including property information 801 is instead displayed in the region where the thumbnail image 800 has been displayed. If the “Preview Screen” mode 704 is set, when the thumbnail image 800 is tapped, a preview screen 802 is displayed on another window. If the “Document Download” mode 705 is set, when the thumbnail image 800 is tapped, a download screen 803 of a document is displayed on another window, and an instruction to download the document is received.

A feature of the present invention lies in a property display unit configured to change the display of a thumbnail image corresponding to a document to the display of the property information of the document in response to a tap of the thumbnail image, as exemplified in the property information 801. This screen transition will be described in more detail below.

Property Display Processing of Document upon Tap of Thumbnail Image

A method of displaying the property information of a document upon a tap of a thumbnail image of the document when the “Property Information” mode 703 mentioned above is set will be described below with reference to FIGS. 6, 7, 9A, and 9B.

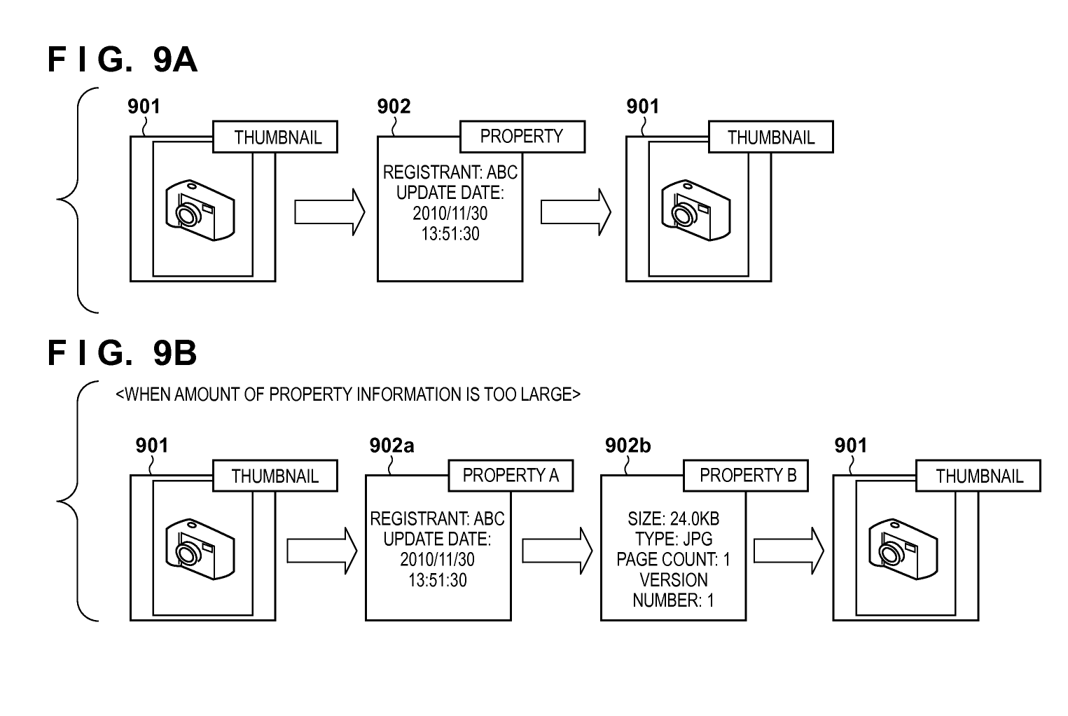

FIGS. 9A and 9B are views each showing how a property screen of a document is displayed in the display region of the thumbnail image 601, displayed on the document thumbnail list display screen 600 shown in FIG. 6, upon a tap of the thumbnail image 601.

A thumbnail image 901 shown in FIG. 9A corresponds to the thumbnail image 601 on the document thumbnail list display screen 600. In this embodiment, a property screen 902 of a document is displayed in the display region of the thumbnail image 901, displayed on the document thumbnail list display screen 600, upon a tap of the thumbnail image 901. The thumbnail image 901 is displayed again upon another tap of the displayed property screen 902.

However, if the amount of property information is too large to display it in one property screen display region, the property information is displayed on a plurality of property screens, separately as property screens 902a and 902b, as shown in FIG. 9B. The plurality of screens may sequentially change from each other every time one of them is tapped. That is, in the case of FIG. 9B, the display is switched from one to another in the order of the thumbnail image 901, property screen 902a, property screen 902b, and thumbnail image 901 every time one of them is tapped. Also, it may be determined whether the property screen is to be divided, in accordance with the size of characters displayed on this property screen.

Property Display Order Sort

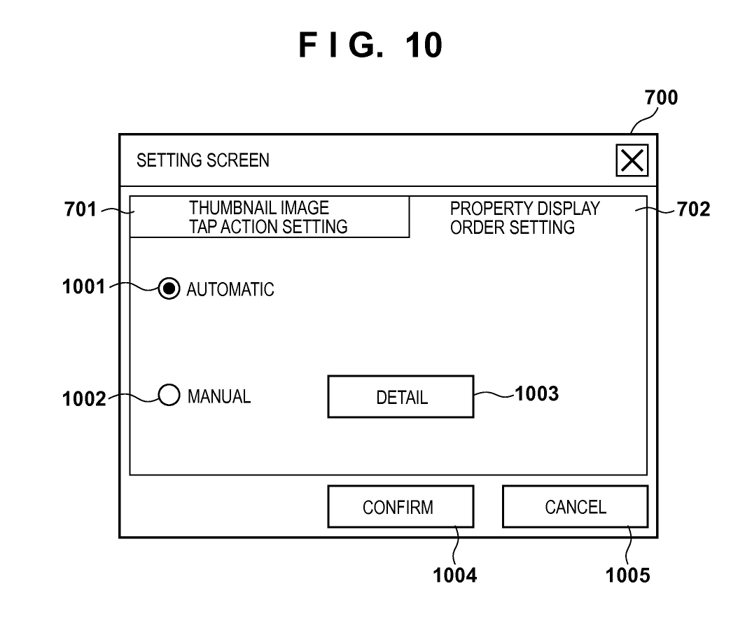

A property display order sort processing method which sets a change in display order of property information displayed on the property screen 902 in this embodiment will be described below with reference to FIGS. 10 to 13.

FIG. 10 shows the property display order setting sheet 702 on the setting screen 700 displayed when the user presses the set button 602 on the document thumbnail list display screen 600 shown in FIG. 6. Setting can be done on the property display order setting sheet 702 when, for example, the “Property Information” mode 703 is selected as the operation mode on the thumbnail image tap action setting sheet 701 shown in FIG. 7.

Automatic sort 1001 or manual sort 1002 can be selected as the display order of property information on the property display order setting sheet 702. When either setting information is selected, and a confirm button 1004 is then pressed, this setting operation is completed. When a cancel button 1005 is pressed, the designated setting information is not reflected. Also, in this embodiment, the automatic sort 1001 is designated as the initial setting state.

Automatic Sort

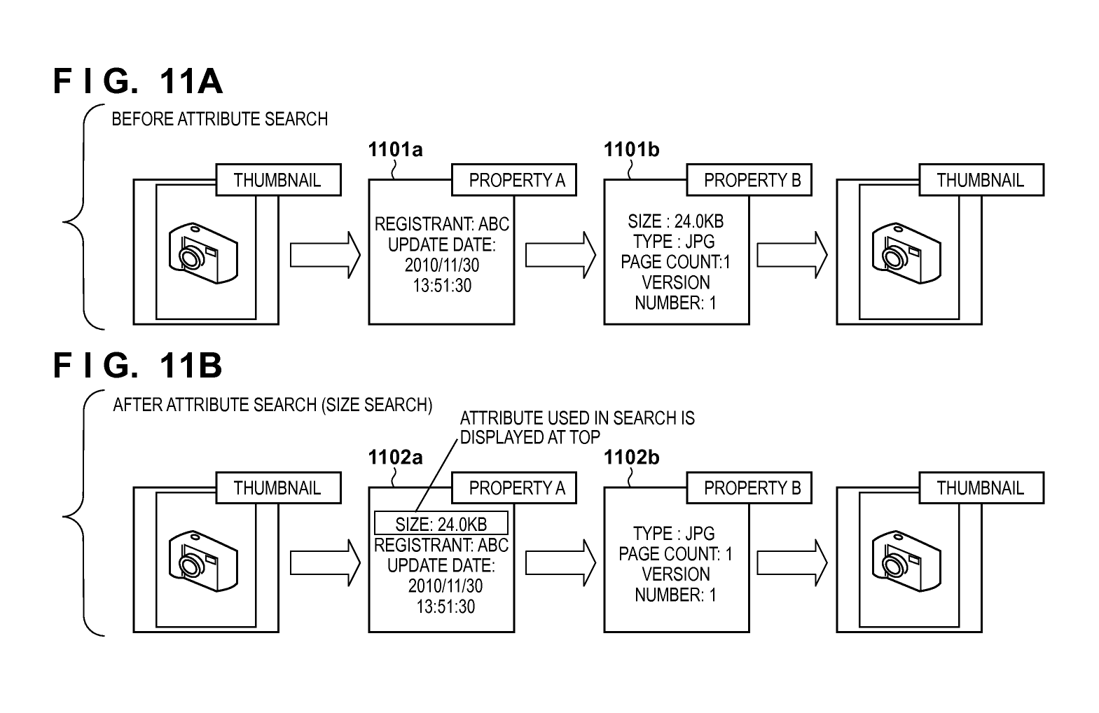

A property display order sort processing method when the automatic sort 1001 according to this embodiment is selected will be described below with reference to FIGS. 11A and 11B.

When the user selects the automatic sort 1001, the display order of property information is automatically switched in accordance with whether the thumbnail images displayed as a list are displayed on the initial display screen (for example, a display screen displayed when the user opens a given folder) or a search result display screen of the attribute search result. That is, when the thumbnail images are displayed as the attribute search result, property attribute information used in an attribute search is automatically sorted at the top of the property display order. Also, the property attribute used in an attribute search is stored in the storage unit 302 of the document management server apparatus 101 upon the attribute search. Note that the display order of property attributes upon a tap of a thumbnail image displayed on the document thumbnail list display screen 600 in the initial state with no attribute search is defined in advance.

FIGS. 11A and 11B are views showing a change in property display order upon a tap of a thumbnail image before and after the user makes an attribute search of a document. The case wherein the property attribute “Size” is used in an attribute search of the document will be taken as an example herein.

FIG. 11A shows property screens 1101a and 1101b which display the display orders of property attributes upon a tap of a normally displayed thumbnail image (a thumbnail image representing no attribute search result). On the other hand, FIG. 11B shows property screens 1102a and 1102b which display the property display orders upon a tap of a thumbnail image displayed as an attribute search result. When the user taps a thumbnail image representing the attribute search result using, for example, the property attribute “Size”, the attribute “Size” moves to the top of the property display order and is displayed on the property screen 1102a, as shown in FIG. 11B. Also, if a plurality of attributes are used in the search, they are moved to the top of the property display order. Note that in this embodiment, the order of a plurality of attributes depends on the order defined in advance before an attribute search.

Manual Sort

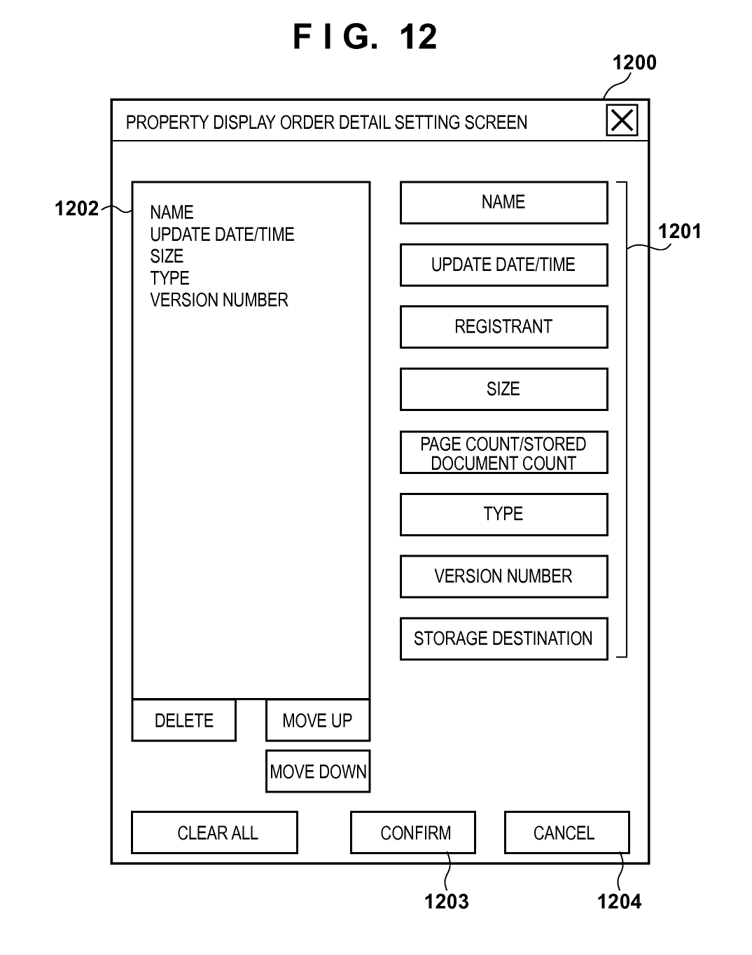

A property display order sort processing method when the manual sort 1002 is selected in FIG. 10 will be described below with reference to FIG. 12. When the user selects the manual sort 1002, the display order of attribute information included in displayed property information is that set by the user. How to set the display order of property attributes will be described below.

FIG. 12 illustrates an example of a property display order detail setting screen 1200 displayed upon pressing of a detail button 1003 on the property display order setting sheet 702 shown in FIG. 10. When the user presses property attribute buttons 1201, property attributes are displayed in a property display order display region 1202. The order of pressing of the property attribute buttons 1201 is the order of display of property attributes on the property screen. The property display order detail setting screen 1200 may also have an input function including, for example, deletion, vertical movement, and batch deletion of selected property attributes.

A property display order setting operation which uses the property display order detail setting screen 1200 shown in FIG. 12 is completed upon pressing of a confirm button 1203. When a cancel button 1204 is pressed, the selected setting information is not reflected. Also, in this embodiment, the initial setting state of the property display order is the order of the “Name”, “Update Time/Date”, “Registrant”, “Size”, “Page Count/Stored Document Count”, “Type”, “Version Number”, and “Storage Destination” from the top. Although FIG. 12 shows the configuration of a screen which allows the user to set only the display order, other attributes such as the size of display characters can be set on the screen. The property display order detail setting screen 1200 implements an attribute setting unit.

Thumbnail Image Tap Action Setting Processing

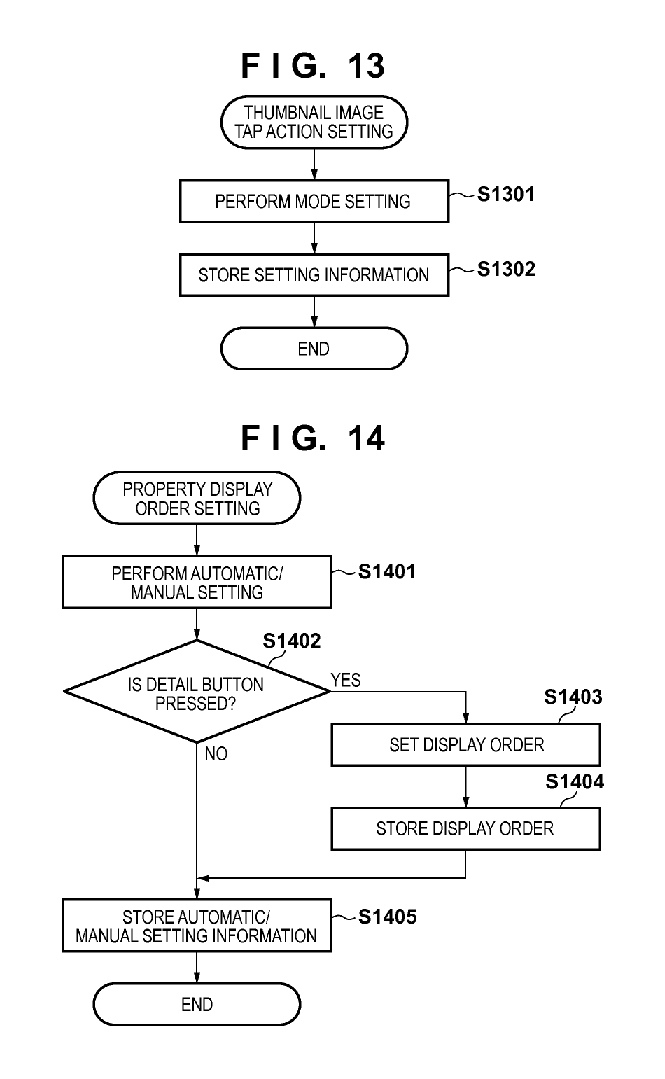

FIG. 13 is a flowchart showing the sequence of processing of storing action setting information in the storage unit 502 upon a tap of a thumbnail image in the state shown in FIG. 7. The CPU in the client apparatus 102 implements this processing by reading out the program stored in, for example, the ROM serving as the storage unit, and executing it.

In step S1301, the display content processing control unit 501 acquires thumbnail image tap action setting information set on the thumbnail image tap action setting sheet 701 by a user operation via the LCD 406.

In step S1302, the display content processing control unit 501 stores the above-mentioned thumbnail image tap action setting information in the storage unit 502. Upon the above-mentioned operation, this processing sequence ends.

Property Display Order Setting Processing

FIG. 14 is a flowchart showing the sequence of processing of storing property display order setting information in the storage unit 502 in FIGS. 10 and 12. The CPU in the client apparatus 102 implements this processing by reading out the program stored in, for example, the ROM serving as the storage unit, and executing it.

In step S1401, the display content processing control unit 501 acquires automatic/manual sort setting information in property display order setting, which is designated on the property display order setting sheet 702 by a user operation via the LCD 406.

In step S1402, the display content processing control unit 501 determines whether the detail button 1003 on the property display order setting sheet 702 is pressed. If the detail button 1003 is pressed (YES in step S1402), the display content processing control unit 501 receives information set by the user via the property display order detail setting screen 1200 to acquire property display order information in step S1403.

In step S1404, the display content processing control unit 501 stores the received property display order information in the storage unit 502. In step S1405, the display content processing control unit 501 stores the set automatic/manual sort setting information in the storage unit 502.

If the detail button 1003 on the property display order setting sheet 702 is not pressed (NO in step S1402), the display content processing control unit 501 stores automatic/manual sort setting information in the storage unit 502 while a property display order is set in the initial state in step S1405. Upon the above-mentioned operation, this processing sequence ends.

Thumbnail Image Tap Operation Processing

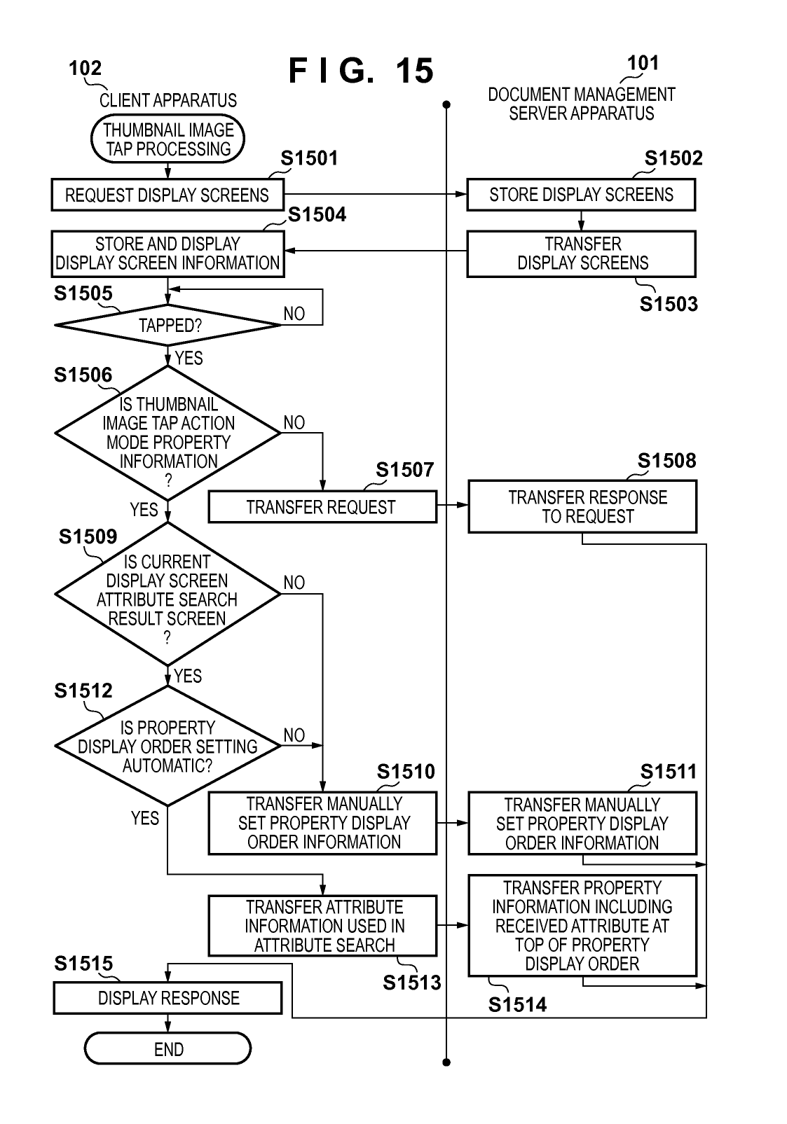

FIG. 15 is a flowchart showing the sequence of processing of changing the display content by setting on the setting screen 700 upon reception of a thumbnail image tap operation in this embodiment. The CPUs in the client apparatus 102 and document management server apparatus 101 implement this processing by reading out the programs stored in, for example, the ROMs serving as the storage units, and executing them.

In step S1501, the display content processing control unit 501 of the client apparatus 102 sends a request to acquire display screens to the display content generation unit 301 of the document management server apparatus 101. The display screens indicate herein all screens which correspond to the document thumbnail list display screen 600 and include a home screen, folder content screen, and search result screen of the document management system.

In step S1502, the display content generation unit 301 generates display screen information to be transferred to the client apparatus 102 having received the request, and stores it in the storage unit 302. The display screen information includes the information of screens to be displayed on the LCD 406 of the client apparatus 102, and property attribute information used in an attribute search when a screen of an attribute search result is to be transferred.

In step S1503, the display content generation unit 301 transfers the generated display screen information to the display content processing control unit 501 of the client apparatus 102. In step S1504, the display content processing control unit 501 stores the display screen information received from the document management server apparatus 101 in the storage unit 502, and displays it on the LCD 406. That is, the document thumbnail list display screen 600 is displayed on the LCD 406 of the client apparatus 102.

If the client apparatus 102 receives a thumbnail image tap operation from the LCD 406 (YES in step S1505), in step S1506 the display content processing control unit 501 acquires thumbnail image tap action setting information stored in the storage unit 502. If the stored thumbnail image tap action setting information is the “Preview Screen” mode 704 or the “Document Download” mode 705 (NO in step S1506), the process advances to step S1507. In step S1507, the display content processing control unit 501 transfers a request for the mode designated in the set thumbnail image tap action setting information to the display content generation unit 301 of the document management server apparatus 101.

In step S1508, the display content generation unit 301 transfers, to the display content processing control unit 501 of the client apparatus 102, a response to the request from the client apparatus 102. When the display content processing control unit 501 receives the response transferred from the document management server apparatus 101 in step S1508, it displays the received response on the LCD 406 in step S1515. That is, the preview screen 802 or the download screen 803 is displayed on the LCD 406 of the client apparatus 102.

On the other hand, if the stored thumbnail image tap action setting information is the “Property Information” mode 703 (YES in step S1506), the process advances to step S1509. In step S1509, the display content processing control unit 501 acquires the current display screen information from the storage unit 502. If the current display screen information indicates a screen other than a search result screen (NO in step S1509), in step S1510 the display content processing control unit 501 acquires, from the storage unit 502, property display order information set on the property display order detail setting screen 1200. At this time, if no property display order information is set on the property display order detail setting screen 1200, the display content processing control unit 501 acquires property display order information set in the initial state. The display content processing control unit 501 transfers the property display order information to the display content generation unit 301 via the I/O control unit 503.

In step S1511, the display content generation unit 301 transfers, to the client apparatus 102, property information sorted in the order specified in the property display order information received from the client apparatus 102. Note that the property information to be transferred may be an image obtained by sequentially displaying pieces of property information, or a character string list obtained by sequentially describing the character strings of pieces of property information.

When the client apparatus 102 receives the property information transferred from the document management server apparatus 101 in step S1511, the display content processing control unit 501 displays the received property information on the LCD 406 in step S1515. That is, the property information 801 is displayed on the LCD 406 of the client apparatus 102.

On the other hand, if the current display screen information indicates a search result screen (YES in step S1509), the process advances to step S1512. In step S1512, the display content processing control unit 501 acquires property display order setting information stored in the storage unit 502. If the stored property display order setting information is the manual sort 1002 (NO in step S1512), the process advances to step S1510.

If the stored property display order setting information is the automatic sort 1001 (YES in step S1512), the display content processing control unit 501 transfers property attribute information used in an attribute search to the display content generation unit 301 of the document management server apparatus 101 in step S1513.

In step S1514, the display content generation unit 301 transfers, to the display content processing control unit 501, property information in which the attribute specified in the property attribute information received from the client apparatus 102 is set at the top of the property display order. When, for example, the attribute “Size” is used in an attribute search, property information having the “Size Attribute” at its top is transferred to the display content processing control unit 501, as in the example shown in FIG. 11B. Also, the property information to be transferred from the document management server apparatus 101 may be an image obtained by sequentially displaying pieces of property information, or a character string list obtained by sequentially describing the character strings of pieces of property information. When the display content processing control unit 501 receives the property information transferred from the document management server apparatus 101 in step S1514, it displays the received property information on the LCD 406 in step S1515. That is, a property screen is displayed in a document thumbnail image region on the LCD 406 of the client apparatus 102.

Note that the number of thumbnail images changed to property screens is not limited to one, and property information corresponding to each thumbnail image can also be displayed upon a tap of this thumbnail image. Also, although document data has been taken as an example in this embodiment, the present invention may be applied to image data or other types of data.

According to the present invention, the user can easily confirm the property information of data monitored by the document management server apparatus 101 even when he or she uses a touch panel terminal. Because property information is displayed in the region where a thumbnail image has been displayed, the user can easily confirm it without opening a new window even when he or she uses a terminal having a small display screen. Also, the user can confirm and compare a plurality of pieces of property information by tapping a plurality of thumbnail images.

A property attribute used in an attribute search is displayed at the top of the property display order, thereby allowing the user to easily, preferentially confirm the required property information.

### Second Embodiment

The second embodiment of the present invention will be described with reference to FIGS. 1 to 7 and 16 to 18. In this embodiment, upon a tap of an icon image (to be referred to as a folder image hereinafter) of a folder, not only a document but also a document list and a subfolder list (to be referred to as folder content information hereinafter) which are contained in the folder are displayed. In this embodiment, if the “Property Information” mode 703 is set on the thumbnail image tap action setting sheet 701 described in the first embodiment, when a folder image is tapped, the folder content information can be displayed within the display region of the folder image. Note that the same parts as in the first embodiment will not be described in the second embodiment.

Property and Folder Content Display upon Tap of Folder

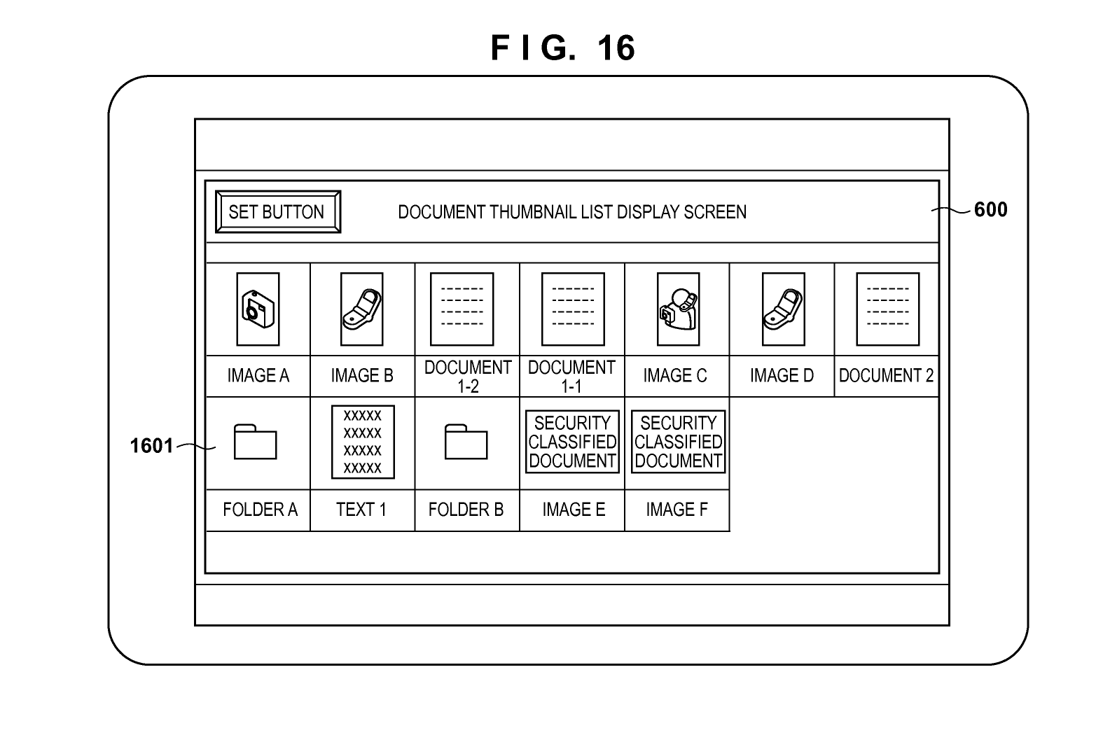

A method of displaying folder content information by folder selection according to this embodiment will be described below with reference to FIGS. 16 to 18.

FIG. 16 shows a document thumbnail list display screen 600 displayed on the screen of a client apparatus 102 when the user accesses (logs in) a document management server apparatus 101 via the client apparatus 102, like FIG. 6. On the document thumbnail list display screen 600, a folder image 1601 is registered in the document management server apparatus 101.

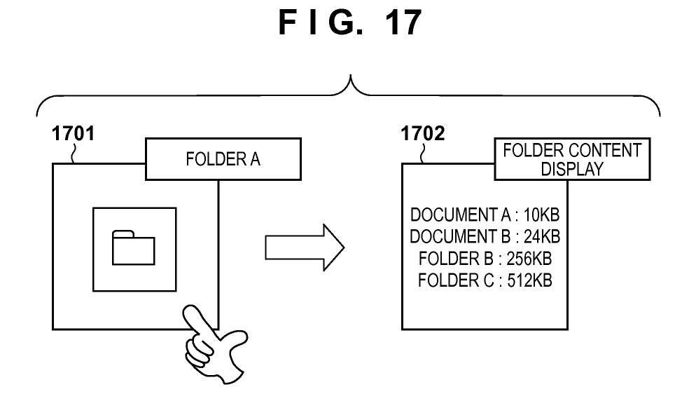

FIG. 17 is a view showing how folder content information is displayed when the user taps a folder image. A folder image 1701 is one of folder images displayed on the document thumbnail list display screen 600.

In this embodiment, folder content information 1702 is displayed in the display region of the folder image 1701 upon a tap of the folder image 1701. However, if the amount of folder content information is too large to display it in one display region, the folder content information may be divided into a plurality of screens and displayed by changing these screens from one to another upon a tap of a folder image, as shown in FIG. 9B of the first embodiment.

Folder Image Tap Operation Processing

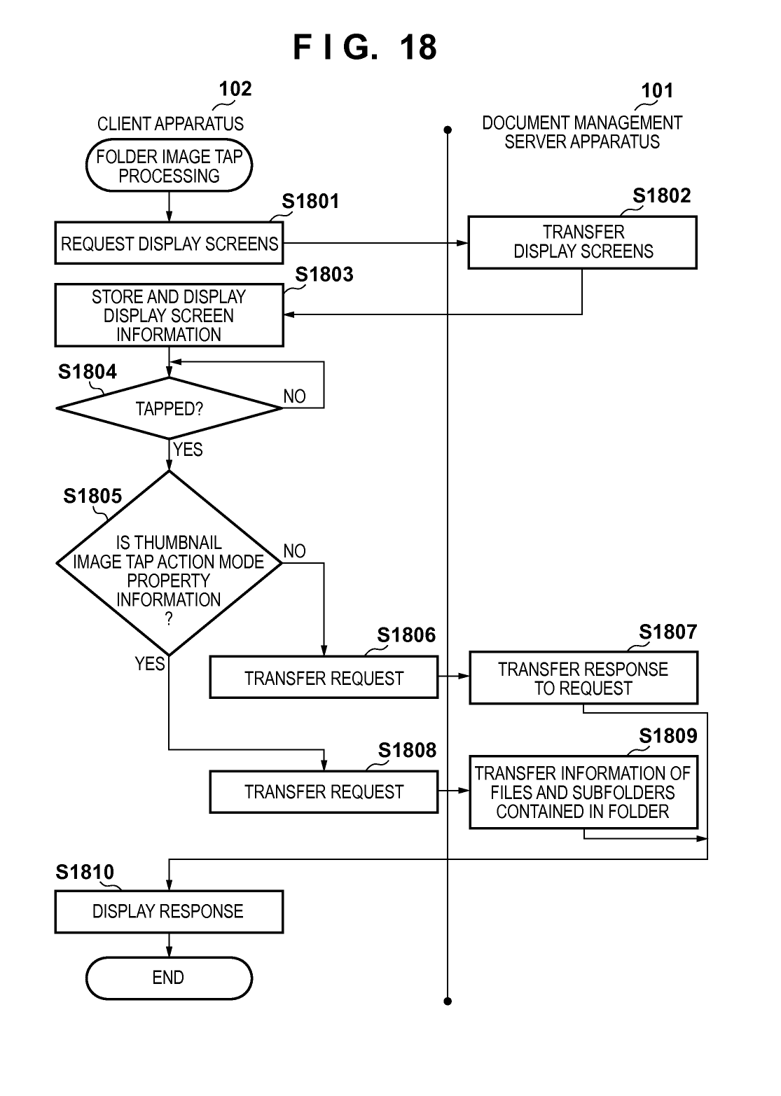

FIG. 18 is a flowchart showing the sequence of processing of displaying folder content information by a display content processing control unit 501 of the client apparatus 102 upon reception of a folder image tap operation by the user. The CPUs in the client apparatus 102 and document management server apparatus 101 implement this processing by reading out the programs stored in, for example, the ROMs serving as the storage units, and executing them.

In step S1801, the display content processing control unit 501 sends a request to acquire display screens to a display content generation unit 301 of the document management server apparatus 101. The display screens indicate herein all screens which correspond to the document thumbnail list display screen 600 and include a home screen, folder content screen, and search result screen of the document management system.

In step S1802, the display content generation unit 301 of the document management server apparatus 101 generates display screen information in response to the request from the client apparatus 102, and transfers it to the display content processing control unit 501 of the client apparatus 102. Note that the display screen information includes screens to be displayed on an LCD 406 of the client apparatus 102, and property attribute information used in an attribute search when an attribute search result is to be displayed.

In step S1803, the display content processing control unit 501 stores the display screen information received from the document management server apparatus 101 in a storage unit 502, and displays it on the LCD 406. That is, the document thumbnail list display screen 600 is displayed on the LCD 406 of the client apparatus 102. If the client apparatus 102 receives a thumbnail image tap operation from the LCD 406 in step S1804 (YES in step S1804), the process advances to step S1805.

In step S1805, the display content processing control unit 501 acquires thumbnail image tap action setting information stored in the storage unit 502. If the stored thumbnail image tap action setting information is a “Preview Screen” mode 704 or a “Document Download” mode 705 (NO in step S1805), the process advances to step S1806. In step S1806, the display content processing control unit 501 transfers a request to open the tapped folder to the display content generation unit 301 of the document management server apparatus 101. In step S1807, the display content generation unit 301 transfers a list display screen of documents and subfolders in the tapped folder to the display content processing control unit 501 of the client apparatus 102 as a response to the request from the client apparatus 102.

When the display content processing control unit 501 receives the response transferred from the document management server apparatus 101 in step S1807, it displays a list display screen on the LCD 406 based on the received response in step S1810. That is, a list display screen of thumbnail images of documents and icon images of subfolders, which are contained in the tapped folder, is displayed on the LCD 406 of the client apparatus 102.

If the stored thumbnail image tap action setting information is a “Property Information” mode 703 (YES in step S1805), the process advances to step S1808. In step S1808, the display content processing control unit 501 transfers a request to acquire the folder content information of the tapped folder image (a list of documents and subfolders in this folder) to the display content generation unit 301 of the document management server apparatus 101.

In step S1809, the display content generation unit 301 transfers the folder content information to the display content processing control unit 501 of the client apparatus 102 as a response to the request from the client apparatus 102. Also, the folder content information to be transferred from the document management server apparatus 101 may be an image obtained by sequentially displaying pieces of folder content information, or a character string list obtained by sequentially describing the character strings of pieces of folder content information. In step S1810, the display content processing control unit 501 displays the folder content information received from the document management server apparatus 101 on the LCD 406. That is, the folder content information 1702 is displayed in the region of a thumbnail image of a folder on the LCD 406 of the client apparatus 102.

Also, in this embodiment, when the last screen of a plurality of divided folder content information screens is tapped, the screen of the folder image may be displayed again, as in the method described in the first embodiment. Moreover, only a property attribute used in a search for the folder may be displayed, or a plurality of property attributes defined in advance may be displayed, as in the folder content display shown in FIG. 17.

According to the second embodiment of the present invention, the user can easily confirm folder content information without opening another window to display a folder, because the information of documents and subfolders in the folder is displayed in the region where the folder image is displayed.

### Third Embodiment

The third embodiment of the present invention will be described with reference to FIGS. 1 to 7 and 19 to 22. In this embodiment, a thumbnail image of the second page is displayed upon a tap of a thumbnail image of the first page, instead of displaying property information upon a tap of a thumbnail image according to the first embodiment.

When a document is registered in a document management server apparatus 101 from an information processing apparatus such as a PC, it is usually easy to identify a thumbnail image of the document to be displayed, upon seeing the first image of the document. On the other hand, when a facsimile document is registered in the document management server apparatus 101 from a facsimile device, it is sometimes difficult to identify a thumbnail image of the document upon seeing a thumbnail image of the first page, because the first page of the facsimile document is often a cover sheet in the same format. In addition, depending on the type of device, a document is often set to be registered after a cover sheet indicating that the document is registered from the device is attached to it. To cope with this situation, in this embodiment, a thumbnail image of the second page is also generated for a facsimile document.

Hence, in this embodiment, thumbnail images of the first and second pages (first and second thumbnail images) are generated for facsimile document data registered from, for example, a facsimile device. Upon a tap of the thumbnail image of the first page (a thumbnail image indicating device registration) displayed on a document thumbnail list display screen, the display screen changes to display the thumbnail image of the second page (a thumbnail image of the document). In this embodiment, if the “Property Information” mode 703 is set on the thumbnail image tap action setting sheet 701 described in the first embodiment, when the thumbnail image of the first page is tapped, the thumbnail image of the second page is displayed. Note that the same parts as in the first embodiment will not be described in the second embodiment.

Different Methods of Displaying Thumbnail Images upon Taps of Thumbnail Images

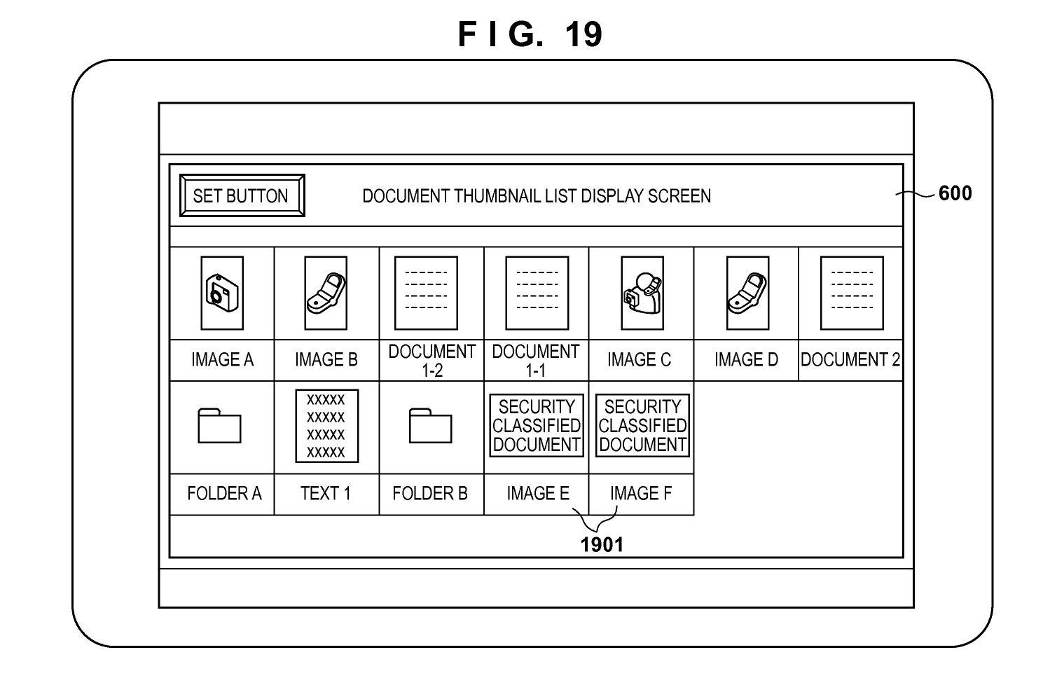

Different methods of displaying thumbnail images upon taps of the thumbnail images in this embodiment will be described below with reference to FIGS. 19 to 22.

FIG. 19 shows a document thumbnail list display screen 600 displayed on the screen of a client apparatus 102 when the user accesses (logs in) a document management server apparatus 101 via the client apparatus 102, like FIG. 6. Thumbnail images 1901 are thumbnail images of the first pages of two documents registered in the document management server apparatus 101 from a device. Note that FIG. 19 illustrates an example of the configurations of the thumbnail images of the first pages. The document thumbnail list display screen 600 implements a device display unit.

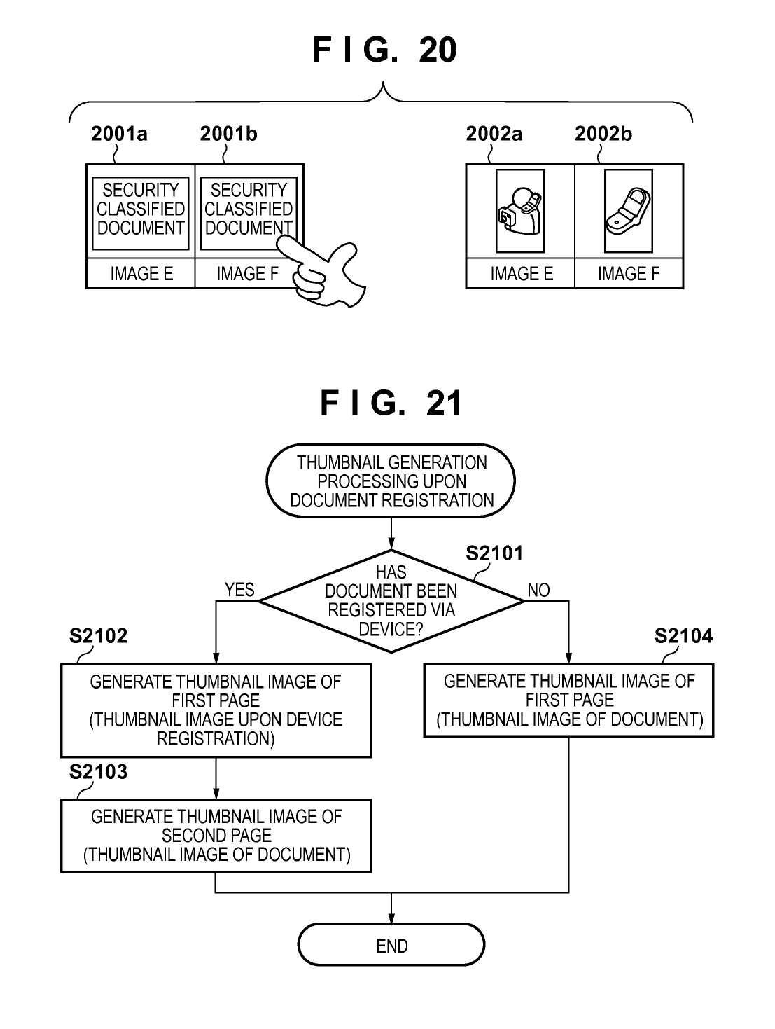

FIG. 20 is a view showing how thumbnail images of the second pages of two different documents registered form a device are displayed upon taps of thumbnail images of the first pages of these documents. Thumbnail images 2001a and 2001b of the first pages are the thumbnail images 1901 of the first pages on the document thumbnail list display screen 600. Upon taps of the thumbnail images 2001a and 2001b of the first pages, thumbnail images 2002a and 2002b of the second pages, respectively, are displayed.

Thumbnail Image Generation Processing upon Document Registration

FIG. 21 is a flowchart showing the sequence of processing of generating a thumbnail image by a display content generation unit 301 when a document is registered in the document management server apparatus 101. The CPU in the document management server apparatus 101 implements this processing by reading out the program stored in, for example, the ROM serving as the storage unit, and executing it.

In step S2101, the display content generation unit 301 acquires device information set when a document is registered, and determines whether the document has been registered by a device. The device information includes the information of a device which has registered a document, such as a PC, a facsimile device, or a multifunctional peripheral.

If the document has been registered from the device (YES in step S2101), the display content generation unit 301 generates a thumbnail image of the first page (a thumbnail image indicating device registration) in step S2102. In step S2103, the display content generation unit 301 generates a thumbnail image of the second page (a thumbnail image of the document).

If the document has not been registered from the device, that is, the document has been registered from the PC (NO in step S2101), the display content generation unit 301 generates a thumbnail image of the first page (a thumbnail image of the document) in step S2104. This processing sequence then ends.

Device Registration Thumbnail Image Tap Operation Processing

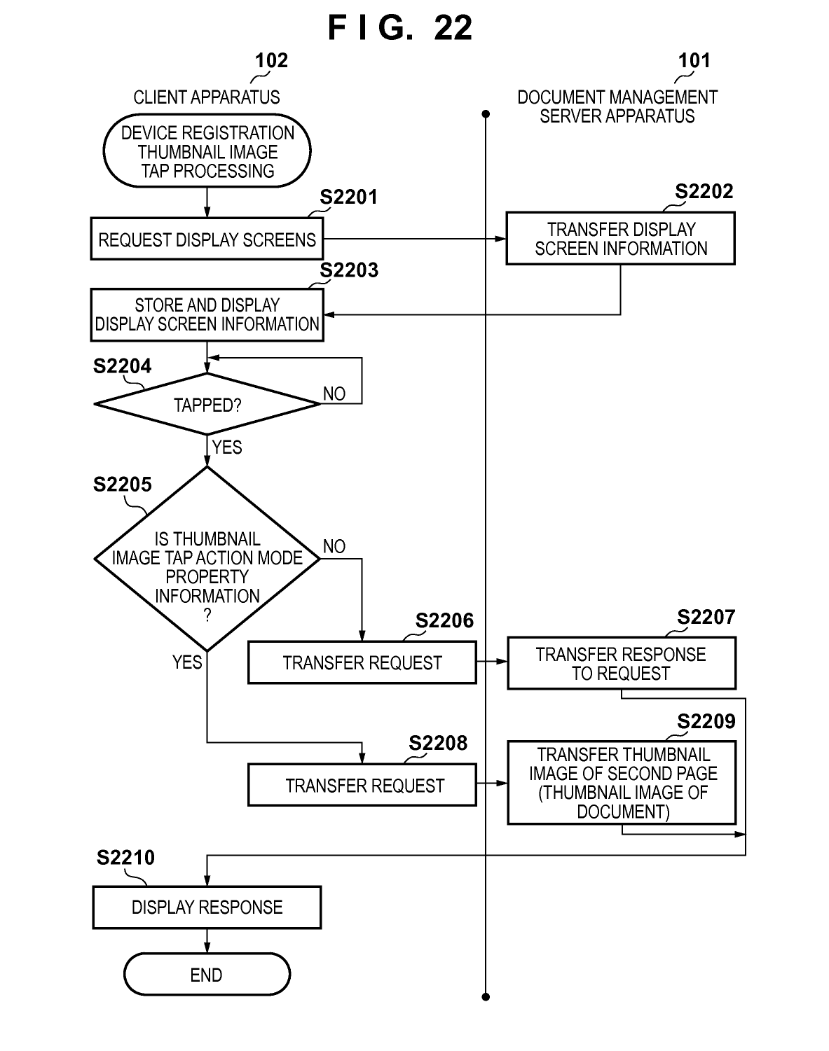

FIG. 22 is a flowchart showing the sequence of processing of displaying a thumbnail image of the second page by a display content processing control unit 501 upon reception of an operation of tapping a thumbnail image of the first page. The CPUs in the client apparatus 102 and document management server apparatus 101 implement this processing by reading out the programs stored in, for example, the ROMs serving as the storage units, and executing them.

In step S2201, the display content processing control unit 501 of the client apparatus 102 sends a request to acquire display screens to the display content generation unit 301 of the document management server apparatus 101. The display screens indicate herein all screens which correspond to the document thumbnail list display screen 600 and include a home screen, folder content screen, and search result screen of the document management system.

In step S2202, the display content generation unit 301 of the document management server apparatus 101 generates display screen information in response to the request from the client apparatus 102, and transfers it to the display content processing control unit 501 of the client apparatus 102. Note that the display screen information includes screen information to be displayed on an LCD 406 of the client apparatus 102.

In step S2203, the display content processing control unit 501 stores the display screen information received from the document management server apparatus 101 in a storage unit 502, and displays it on the LCD 406. That is, the document thumbnail list display screen 600 is displayed on the LCD 406 of the client apparatus 102.

If the client apparatus 102 receives a thumbnail image tap operation via the LCD 406 (YES in step S2204), the process advances to step S2205. In step S2205, the display content processing control unit 501 acquires thumbnail image tap action setting information stored in the storage unit 502. If the stored thumbnail image tap action setting information is a “Preview Screen” mode 704 or a “Document Download” mode 705 (NO in step S2205), the process advances to step S2206. In step S2206, the display content processing control unit 501 transfers a request corresponding to the setting information to the display content generation unit 301 of the document management server apparatus 101.

In step S2207, the display content generation unit 301 of the document management server apparatus 101 transfers, to the display content processing control unit 501 of the client apparatus 102, a response to the request received from the client apparatus 102.

When the display content processing control unit 501 receives the response transferred from the document management server apparatus 101, it displays the received response on the LCD 406 in step S2210. That is, a preview screen 802 or a download screen 803 is displayed on the LCD 406 of the client apparatus 102.

If the stored thumbnail image tap action setting information is the “Property Information” mode 703 (YES in step S2205), the process advances to step S2208. In step S2208, the display content processing control unit 501 transfers a request to acquire a thumbnail image of the second page to the display content generation unit 301 of the document management server apparatus 101.

In step S2209, the display content generation unit 301 transfers a thumbnail image of the second image to the display content processing control unit 501 of the client apparatus 102 in response to the request from the client apparatus 102. In step S2210, the display content processing control unit 501 displays the thumbnail image of the second page received from the document management server apparatus 101 on the LCD 406. That is, when the thumbnail image 2001a is tapped, the thumbnail image 2002a is displayed in the display region of the thumbnail image 2001a on the LCD 406 of the client apparatus 102.

Also, in this embodiment, when a displayed thumbnail image of a document is tapped, a property screen of the document may be displayed using the same method as described in the first embodiment.

According to the third embodiment of the present invention, the user can confirm a document, which is registered from a device and has a content that cannot be identified upon seeing a thumbnail image, without downloading it.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer- readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-231095, filed Oct. 20, 2011, which is hereby incorporated by reference herein in its entirety.

What is claimed is:

1. A display apparatus including a display unit which receives input upon a tap on a display screen, comprising:
a property display unit configured, when a thumbnail image of data displayed on the display screen is tapped, to change a display region of the thumbnail image to a property screen indicating property information of the data corresponding to the thumbnail image.

2. The apparatus according to claim 1, wherein said property display unit displays attribute information, which is used in a search for the data to be displayed on the display screen among pieces of attribute information included in the property information, upon moving the attribute information to a top of the property screen.

3. The apparatus according to claim 1, further comprising:
an attribute setting unit configured to receive setting of the attribute information, to be displayed on the property screen, among the pieces of attribute information included in the property information,
wherein said property display unit displays the attribute information set by said attribute setting unit, and a property screen corresponding to a display order specified in the attribute information.

4. The apparatus according to claim 1, wherein said property display unit constructs the property screen using a plurality of screens, and displays another property screen by switching the property screen from one to another every time the property screen is tapped.

5. The apparatus according to claim 1, further comprising:
a mode setting unit configured to set an operation mode upon a tap of the thumbnail image; and
a switching unit configured to switch a display operation upon the tap of the thumbnail image, in accordance with the mode set by said mode setting unit.

6. The apparatus according to claim 5, wherein the operation mode upon the tap of the thumbnail image, which is set by said mode setting unit, is one of
a mode in which the display region of the thumbnail image is changed to the property screen of the data corresponding to the thumbnail image by said property display unit,
a mode in which the data corresponding to the thumbnail image is downloaded, and
a mode in which a preview screen of the data corresponding to the thumbnail image is displayed.

7. The apparatus according to claim 1, further comprising a folder content display unit configured, when an icon image of a folder displayed on the display screen is tapped, to change a display region of the icon image to a screen of a list of data and a list of subfolders, which are contained in the folder.

8. The apparatus according to claim 7, wherein said folder content display unit displays attribute information of property information, used in a search for the folder corresponding to the tapped icon image, as property information of the data and the subfolders contained in the folder.

9. The apparatus according to claim 1, further comprising:
a device display unit configured, when the data corresponding to the thumbnail image to be displayed on the display screen has been registered via a device, to display on the display screen a first thumbnail image indicating to that effect,
wherein when the first thumbnail image is tapped, said device display unit displays a second thumbnail image indicating the data corresponding to the thumbnail image to be displayed on the display screen.

10. A display apparatus that is connected to an external apparatus which manages data, and includes a display unit which receives input upon a tap on a display screen, comprising:
an acquisition unit configured, when a thumbnail image of data displayed on the display screen is tapped, to acquire property information of the data corresponding to the thumbnail image from the external apparatus; and
a property display unit configured to change a display region of the thumbnail image to a property screen indicating the property information acquired by said acquisition unit.

11. A display method for a display apparatus including a display unit which receives input upon a tap on a display screen, comprising:
a property display step of, when a thumbnail image of data displayed on the display screen is tapped, changing a display region of the thumbnail image to a property screen indicating property information of the data corresponding to the thumbnail image.

12. A display method for a display apparatus that is connected to an external apparatus which manages data, and includes a display unit which receives input upon a tap on a display screen, comprising:
an acquisition step of, when a thumbnail image of data displayed on the display screen is tapped, acquiring property information of the data corresponding to the thumbnail image from the external apparatus; and
a property display step of changing a display region of the thumbnail image to a property screen indicating the property information acquired in the acquisition step.

13. A non-transitory computer-readable medium storing a program for causing a computer to function as:
a property display unit configured, when a thumbnail image of data displayed on a display screen of a display unit which receives input upon a tap on the display screen is tapped, to change a display region of the thumbnail image to a property screen indicating property information of the data corresponding to the thumbnail image.

14. A non-transitory computer-readable medium storing a program for causing a computer to function as:
an acquisition unit configured, when a thumbnail image of data which is managed by an external apparatus and displayed on a display screen of a display unit which receives input upon a tap on the display screen is tapped, to acquire property information of the data corresponding to the thumbnail image from the external apparatus; and
a property display unit configured to change a display region of the thumbnail image to a property screen indicating the property information acquired by the acquisition unit.
